(19) United States
(12) Patent Application Publication
(10) Pub. No.: US 2015/0348210 A1
(43) Pub. Date: Dec. 3, 2015

(54) SYSTEM AND METHOD FOR GENERATING ALTERNATIVE ELECTRONIC RECEIPT DISPLAYS ON A COMPUTING DEVICE

(71) Applicant: TOSHIBA TEC KABUSHIKI KAISHA, Tokyo (JP)

(72) Inventor: Nobuhiro INAGAWA, Mishima Shizuoka (JP)

(21) Appl. No.: 14/721,927

(22) Filed: May 26, 2015

(30) Foreign Application Priority Data
May 29, 2014 (JP) 2014-111559

(51) Int. Cl. G06Q 40/00; H04W 4/00; G06F 3/0484

(52) U.S. Cl. CPC G06Q 40/12; G06F 3/04842; G06F 3/04847; H04W 4/005

(57) ABSTRACT

A computing device includes a communication unit configured to communicate wirelessly with a server that stores electronic receipt data, a memory unit configured to temporarily store electronic receipt data received from the server through the communication unit, a display unit configured to display an user interface including a plurality of user selectable elements, each corresponding to a display format of a group of electronic receipts, and a control unit configured to control the display unit to display the electronic receipts corresponding to the electronic receipt data stored in the memory unit, in one of the display formats selected through the user interface.

### CROSS-REFERENCE TO RELATED APPLICATION

This application is based upon and claims the benefit of priority from Japanese Patent Application No. 2014-111559, filed May 29, 2014, the entire contents of which are incorporated herein by reference.

### FIELD

Embodiments described herein relate generally to system for generating alternative electronic receipt displays on a computing device.

### BACKGROUND

One type of an electronic receipt system electronically transmits an electronic data of a purchase transaction at a store (i.e., an electronic receipt) to a computing device of a customer, such as a mobile device, instead of a paper receipt that is conventionally handed to the customer during the purchase transaction. The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction. In addition to these advantages, it would be convenient to the customer if the computing device of the customer can display the electronic receipt in a manner differently from and more flexibly with respect to the paper receipt.

### DESCRIPTION OF THE DRAWINGS

FIG. 1 illustrates an overall configuration of an electronic receipt system according to an embodiment.

FIG. 2 is a block diagram of a portable terminal in the electronic receipt system.

FIG. 3 is a block diagram of a POS terminal in the electronic receipt system.

FIG. 4 is a block diagram of an electronic receipt server in the electronic receipt system.

FIG. 5 is a block diagram of an electronic receipt management server in the electronic receipt system.

FIG. 6 illustrates a functional configuration of the portable terminal.

FIGS. 7A and 7B are flow charts illustrating a flow of a format setting process.

FIG. 8 illustrates an example of an initial screen.

FIG. 9 illustrates an example of a format setting screen.

FIG. 10 illustrates an example of a detailed format setting screen.

FIG. 11 illustrates an example of a format file selection screen.

FIG. 12 is a flow chart illustrating a flow of a process of displaying an electronic receipt.

FIGS. 13-15 each illustrate an example of an electronic receipt image.

### DETAILED DESCRIPTION

In general, according to one embodiment, a computing device includes a communication unit configured to communicate wirelessly with a server that stores electronic receipt data, a memory unit configured to temporarily store electronic receipt data received from the server through the communication unit, a display unit configured to display an user interface including a plurality of user selectable elements, each corresponding to a display format of a group of electronic receipts, and a control unit configured to control the display unit to display the electronic receipts corresponding to the electronic receipt data stored in the memory unit, in one of the display formats selected through the user interface.

An embodiment will be described below with reference to the accompanying drawings.

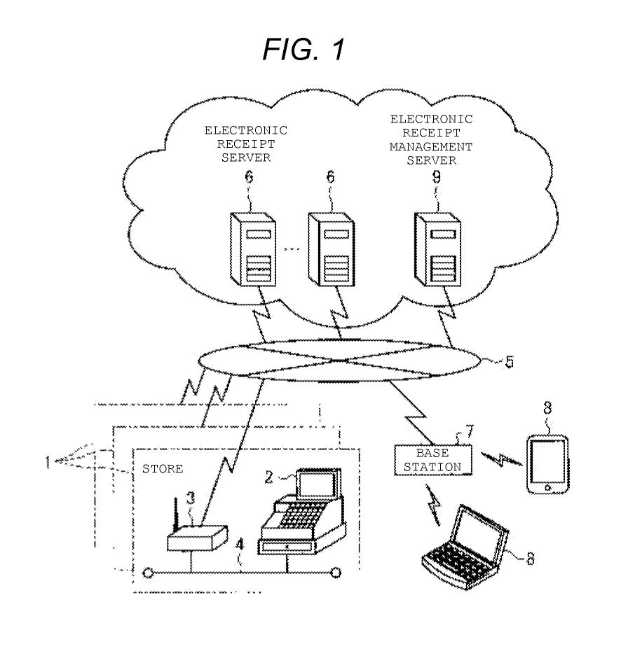

FIG. 1 illustrates an overall configuration of an electronic receipt system according to an embodiment. As illustrated in FIG. 1, a store 1 is provided with a point of sales (POS) terminal 2 (although only one terminal is shown in FIG. 1, a plurality of terminals may be provided), which is a merchandise sales data processing apparatus that performs merchandise sales data processing, and a router 3. The POS terminal 2 and the router 3 are connected to each other through an in-store local area network (LAN) 4. The router 3 is a device that connects the in-store LAN 4 and a network 5, which is the Internet or a virtual private network (VPN). Although not particularly shown in FIG. 1, the store 1 may be provided with a store server that controls the entire POS terminal 2.

A plurality of electronic receipt servers 6 is connected to the network 5. Each of the electronic receipt servers 6 is provided for each of business entities (companies), which are sellers of merchandise or providers of a service, such as a convenience store, (hereinafter, referred to as a store), and functions as a receipt management server for a business entity, which stores and manages electronic receipt information for each company code indicating a company operating a store. Here, the electronic receipt server 6 may also serve as a headquarter server of a POS system having functions such as sales management, sales analysis, and inventory control of the company operating the store.

In addition, a portable terminal 8 is connected to the network 5 through a base station 7 that performs wireless communication according to a standard such as wireless fidelity (Wi-Fi, registered trademark). The portable terminal 8 is an information processing apparatus such as a smart phone, a mobile phone, a personal digital assistant (PDA), or a tablet computer installed with a Web browser. The portable terminal 8 may be an information processing apparatus such as a personal computer.

Further, an electronic receipt management server 9 is also connected to the network 5. The electronic receipt management server 9 functions as a customer receipt management server that collectively stores and manages electronic receipt information of multiple companies operating stores. A user who is registered as a member in advance may obtain electronic receipt information from the electronic receipt management server 9 using the portable terminal 8 through the network 5. The electronic receipt management server 9 is managed by a third-party organization other than the company managing electronic receipt information using, for example, the electronic receipt server 6. Alternatively, the electronic receipt server 6 may also be managed by a third-party organization or the like.

Further alternatively, one server may perform functions of both the electronic receipt server 6 and the electronic receipt management server 9. In addition, a service (application) of a function of collectively managing electronic receipt information of multiple companies using a plurality of company codes, which specify the companies, may be provided, for example, in the form of software as a service (SaaS), which is a type of cloud computing.

In the electronic receipt system having such a configuration, electronic receipt information indicating details of a purchase transaction is generated through merchandise sales data processing by the POS terminal 2 of the store 1 and transmitted to the electronic receipt management server 9 through the network 5 and the electronic receipt server 6. The electronic receipt management server 9 transmits electronic receipt information to the portable terminal 8 of a user, who is a member. The user may operate the portable terminal 8 to display the electronic receipt information on the display unit thereof and confirm the details of the purchase transaction.

In addition, the electronic receipt management server 9 may upload the electronic receipt information on a Web. The portable terminal 8 with a Web browser may download the electronic receipt information uploaded on a Web using a uniform resource locator (URL) and display the electronic receipt information on the display unit. Here, application software may be installed for browsing the electronic receipt information on the portable terminal 8.

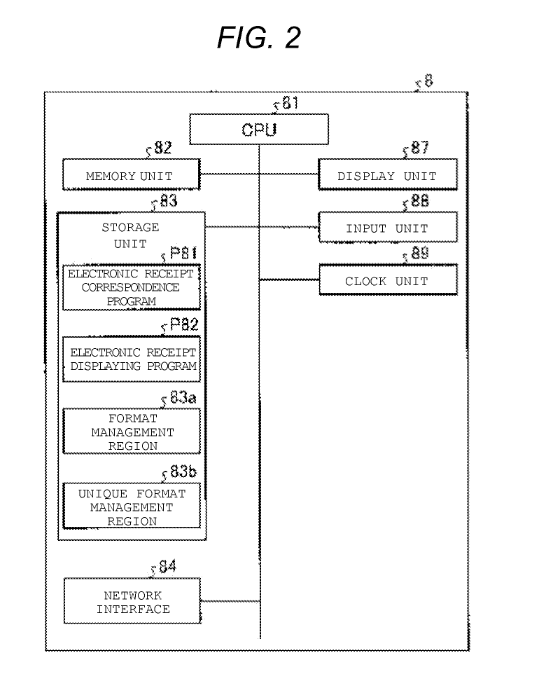

The portable terminal 8 stores a membership code and a password, which are acquired by a user through membership registration, in a storage unit 83 (see FIG. 2) or the like. The membership code may be output in a form of, for example, a bar code, a two-dimensional code, data transmission using information communication through near field communication (NFC), which is near field type wireless communication, and the like.

Further, when a membership code acquired by a user in order to receive an electronic receipt service is associated with a membership code related to an existing company membership card or a point service managed by a company such as a chain store, the correlation of the codes may be stored in the POS terminal 2 of each retail store or the portable terminal 8 of each user.

Next, the respective units constructing the electronic receipt system of the present embodiment will be described in detail.

First, the portable terminal 8, which is an information processing apparatus, will be described with reference to a block diagram of FIG. 2.

Here, FIG. 2 is a block diagram of the portable terminal 8. As illustrated in FIG. 2, the portable terminal 8 includes a central processing unit (CPU) 81, a memory unit 82, a storage unit 83, a network interface 84, a display unit 87, an input unit 88, and a clock unit 89. The CPU 81 controls the overall portable terminal 8. The memory unit 82 temporarily stores data. The CPU 81 may perform reading from and writing to the storage unit 83, using a command, and the storage unit 83 stores a program, data, and the like. The network interface 84 is connected to various public networks including the network 5. The display unit 87 displays various kinds of information. The input unit 88 is a key provided on a touch panel laminated on the display unit 87 or a housing. The clock unit 89 measures time.

The storage unit 83 contains an electronic receipt correspondence program P81, an electronic receipt displaying program P82, a format management region 83a, and a unique format management region 83b. The electronic receipt correspondence program P81 is not only a Web browser for browsing various kinds of information (contents) uploaded on the Web, but also a program for receiving electronic receipt information generated after a purchase transaction through merchandise sales data processing from the electronic receipt management server 9. The electronic receipt displaying program P82 is a program for browsing the received electronic receipt information.

The format management region 83a is a region storing a format, which is a form of an electronic receipt. The format management region 83a stores format files which are set in advance. For example, the format files include a standard format, a format in which the order of the display of merchandise is changed, a format in which additional information is displayed, and the like. One of the format files is selected by setting.

In addition, the unique format management region 83b stores a format file of an electronic receipt. The unique format management region 83b stores a format file which is created by a user. The format file is a file in which display formats such as a store name logo, a merchandise name, and a price which are displayed on an electronic receipt, are set, and it is possible to change the image of the format file so as to be larger than that of a standard format. The display format includes a display position, a character size, a font, the setting of the presence or absence of display, and the like. Thereby, a user may set a unique format having a large character size of a price, for example, without displaying a store name logotype.

The electronic receipt correspondence program P81 and the electronic receipt displaying program P82, which are executed by the portable terminal 8, are files in an installable format or an executable format, and are recorded and provided in a non-transitory computer-readable storage medium such as a CD-ROM, a flexible disk (FD), a CD-R, or a digital versatile disk (DVD).

Alternatively, the electronic receipt correspondence program P81 and the electronic receipt displaying program P82 may be being downloaded through a network such as the Internet and stored in a computer connected to the network. In addition, the electronic receipt correspondence program P81 and the electronic receipt displaying program P82 may be provided or distributed through a network such as the Internet.

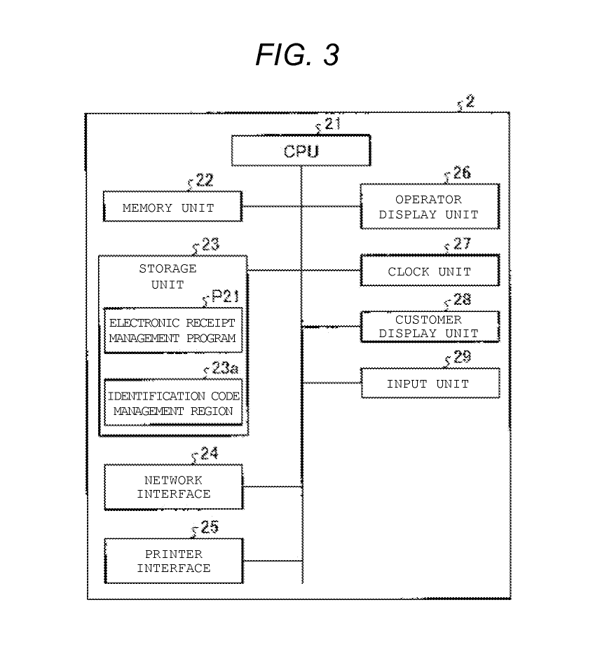

Next, the POS terminal 2, which is a merchandise sales data processing apparatus, will be described with reference to a block diagram of FIG. 3.

Here, FIG. 3 is a block diagram of the POS terminal 2. As illustrated in FIG. 3, the POS terminal 2 includes a CPU 21, a memory unit 22, a storage unit 23, a network interface 24, a printer interface 25, an operator display unit 26, a clock unit 27, a customer display unit 28, and an input unit 29. The CPU 21 controls the overall POS terminal 2. The memory unit 22 temporarily stores data. The CPU 21 may perform reading from and writing to the storage unit 23, using a command, and the storage unit 23 stores a program, data, and the like. The network interface 24 is connected to the LAN 4 within a store. The printer interface 25 is connected to a printer. The operator display unit 26 displays various kinds of information towards an operator. The clock unit 27 measures time. The customer display unit 28 displays various kinds of information towards a customer. The input unit 29 is a key provided on a touch panel laminated on the operator display unit 26 or a housing.

The storage unit 23 contains an identification code management region 23a as a region for storing in advance a company code (identification code of a company operating a store), a business type and business category code, a store code indicating the store 1 having the POS terminal 2 installed therein, and the like, in addition to a POS number of the POS terminal 2.

Here, the business type and business category code is a code (classification code) for classifying business types and business categories of stores as, for example, a convenience store, a supermarket, a department store, a pharmacy, and a restaurant. Such business type and business categories may be arbitrarily modified according to user's preference. Here, the company code (identification code of a company operating a store) and the business type and business category code may be registered in the electronic receipt server 6.

In addition, software for executing various POS work, including merchandise sales data processing, is installed in the storage unit 23 in advance. Further, an electronic receipt management program P21 for processing the electronic receipt information, which is electronically processed instead of a paper receipt or an acknowledgment printed out and issued at the time of merchandise sales data processing, is installed in the storage unit 23 in advance. Further, the storage unit stores issuance conditions of electronic receipt information, which is set for each membership code distributed from the electronic receipt management server 9.

Here, the electronic receipt management program P21 executed by the POS terminal 2 is a file in an installable format or an executable format, and is recorded and provided in a non-transitory computer-readable storage medium such as a CD-ROM, a flexible disk (FD), a CD-R, or a digital versatile disk (DVD).

Alternatively, the electronic receipt management program P21 executed by the POS terminal 2 may be downloaded through a network such as the Internet and stored in a computer connected to the network. In addition, the electronic receipt management program P21 may be provided or distributed through a network such as the Internet.

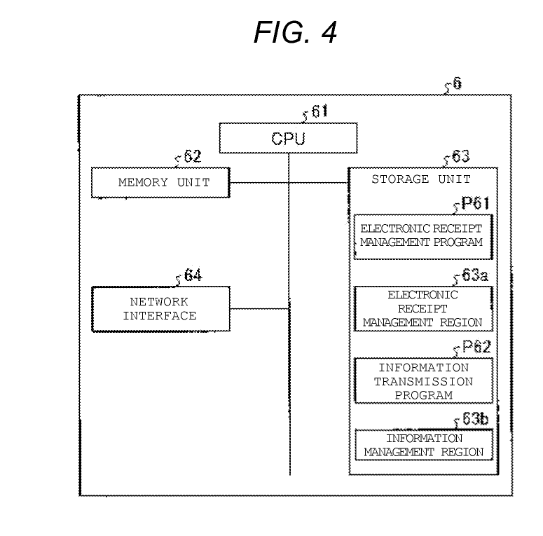

Next, the electronic receipt server 6 functioning as a receipt management server for a company will be described with reference to a block diagram of FIG. 4.

Here, FIG. 4 is a block diagram of the electronic receipt server 6. The electronic receipt server 6 includes a CPU 61, a memory unit 62, a storage unit 63, and a network interface 64. The CPU 61 controls the overall electronic receipt server 6. The memory unit 62 temporarily stores data. The CPU 61 may perform reading from and writing to the storage unit 63 using a command, and the storage unit 63 stores a program, data, and the like. The network interface 64 is connected to the network 5.

The storage unit 63 contains an electronic receipt management region 63a as a region for storing electronic receipt information for a company operating one or more stores. The electronic receipt information includes a company code (identification code of a company operating a store), a business type and business category code, one or more store codes, user's membership codes, POS numbers of the POS terminals 2, receipt numbers, merchandise sales data, and the like.

In addition, an electronic receipt management program P61 for managing electronic receipt information received from the POS terminal 2 of each store 1 in the electronic receipt management region 63a is installed in the storage unit 63 in advance.

In addition, an information transmission program P62 for transmitting the electronic receipt information managed in the electronic receipt management region 63a to the electronic receipt management server 9 is also installed in the storage unit 63 in advance.

Further, the storage unit 63 contains an information management region 63b that stores additional information associated with a certain merchandise, member, company, and store. Here, the additional information is access information such as a URL linked to a home page associated with a company's promotion program, a URL linked to a home page associated with a company's CM, or a URL linked to a company's coupon.

Here, the electronic receipt management program P61 and the information transmission program P62, which are executed by the electronic receipt server 6, are files in an installable format or an executable format, and are recorded and provided in a non-transitory computer-readable storage medium such as a CD-ROM, a flexible disk (FD), a CD-R, or a digital versatile disk (DVD).

Alternatively, the electronic receipt management program P61 and the information transmission program P62 may be downloaded through a network such as the Internet and stored in a computer connected to the network. In addition, the electronic receipt management program P61 and the information transmission program P62 may be provided or distributed through a network such as the Internet.

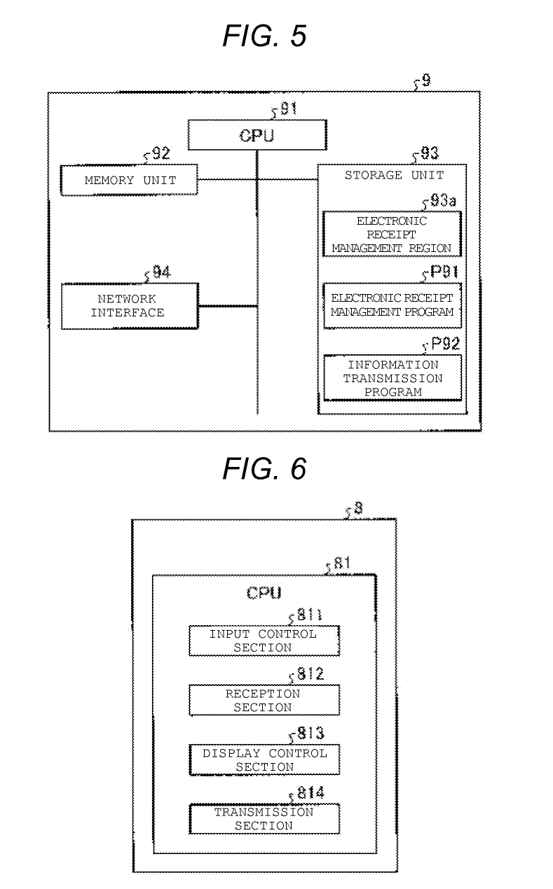

Next, the electronic receipt management server 9 functioning as a receipt management server for a customer will be described with reference to a block diagram of FIG. 5.

Here, FIG. 5 is a block diagram of the electronic receipt management server 9. The electronic receipt management server 9 includes a CPU 91, a memory unit 92, a storage unit 93, and a network interface 94. The CPU 91 controls the overall electronic receipt management server 9. The memory unit 92 temporarily stores data. The CPU 91 may perform reading from and writing to the storage unit 93 using a command, and the storage unit 93 stores a program, data, and the like. The network interface 94 is connected to the network 5.

The storage unit 93 contains an electronic receipt management region 93a as a region for collectively storing pieces of electronic receipt information of multiple companies, each operating one or more stores. In more detail, the electronic receipt management region 93a manages electronic receipt information and additional information of the multiple companies. The electronic receipt information includes, with respect to each of the multiple companies, a membership code, a company code (identification code of a company operating a store), a business type and business category code, one or more store codes, POS numbers of the POS terminals 2, receipt numbers, merchandise sales data, and the like.

In addition, an electronic receipt management program P91 for managing the additional information and the electronic receipt information, which are received from the electronic receipt server 6 of each company, in the electronic receipt management region 93a is installed in the storage unit 93 in advance.

In addition, an information transmission program P92 for transmitting the electronic receipt information and additional information of desired merchandise to the portable terminal 8 is installed in the storage unit 93 in advance.

Here, the electronic receipt management program P91 and the information transmission program P92, which are executed by the electronic receipt management server 9, are files in an installable format or an executable format, and are recorded and provided in a non-transitory computer-readable storage medium such as a CD-ROM, a flexible disk (FD), a CD-R, or a digital versatile disk (DVD).

Alternatively, the electronic receipt management program P91 and the information transmission program P92 may be downloaded through a network such as the Internet and stored in a computer connected to the network. In addition, the electronic receipt management program P91 and the information transmission program P92 may be provided or distributed through a network such as the Internet.

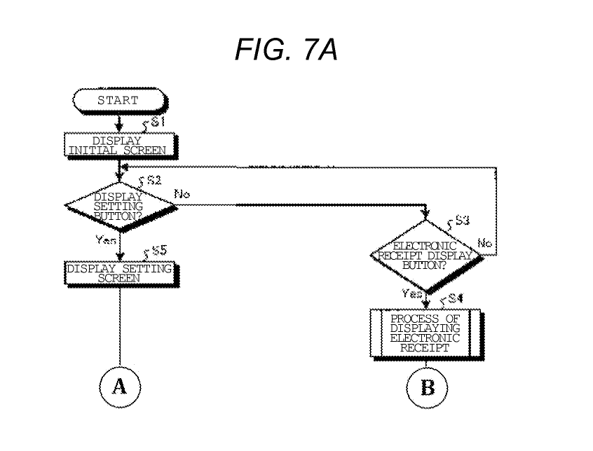

Next, characteristic functions of the portable terminal 8 according to the embodiment will be described. FIG. 6 is a block diagram illustrating a functional configuration of the portable terminal 8. The CPU 81 functions as an input control section 811, a reception section 812, a display control section 813, and a transmission section 814, by operating in accordance with a control program stored in the memory unit 82 or the storage section 83.

The input control section 811, which is an input section, receives a command of changing a format, which is a form of an electronic receipt displayed on the display unit 87, through the input unit 88. Methods of setting the format are roughly classified into a simple format setting, a detailed format setting, and a customized format setting through which a unique format file created by a user and stored in the unique format management region 83b is set. When a format is set, an electronic receipt is displayed in the set format since then.

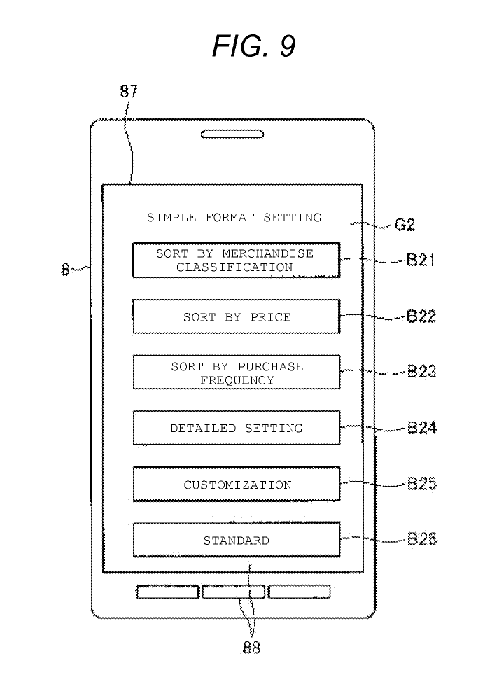

The simple format setting is a simple format setting method of setting a format preset in the format management region 83a in advance. When the simple format setting is selected, the input control section 811 receives selection of a format from a plurality of formats, which are associated with different display concepts. In more detail, the input control section 811 receives an input through a setting screen such as, for example, a format setting screen (see FIG. 9).

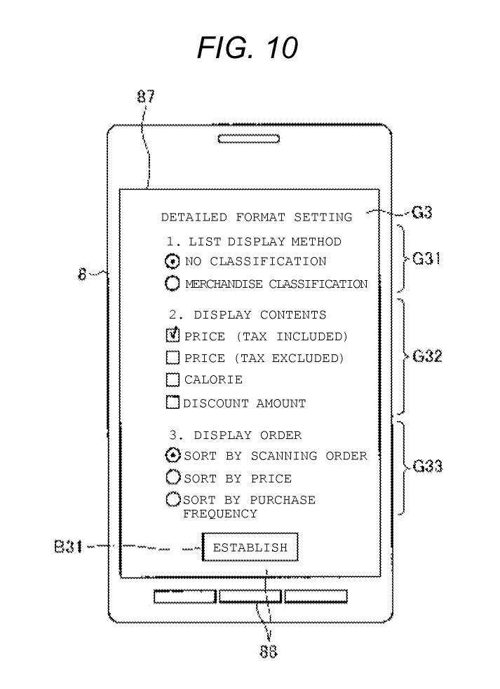

The detailed format setting is a format setting method of setting a format modified according to user's preference instead of the preset format. When the detailed format setting is selected, the input control section 811 receives the modification setting of a format performed through a screen displaying a plurality of items related to the form of an electronic receipt. In more detail, the input control section 811 receives an input through a setting screen such as, for example, a format detailed setting screen (see FIG. 10).

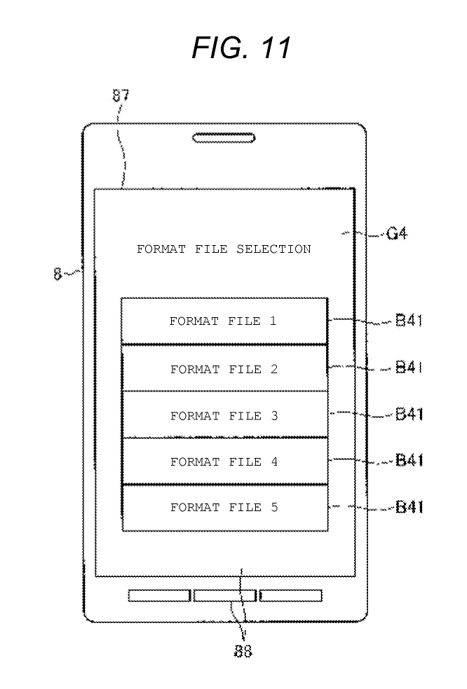

The customized format setting is a format setting method of setting a format file that is uniquely created by a user and is stored in the unique format management region 83b of the storage unit 83, as a format to display an electronic receipt. The input control section 811 receives an input through a screen for selecting the format file. In more detail, the input control section 811 receives an input through a selection screen such as, for example, a format file selection screen (see FIG. 11). Here, the format file may be a file created in a personal computer or in the portable terminal 8.

The reception section 812, which is a reception section, receives electronic receipt information including merchandise sales data of purchased merchandise in one purchase transaction. The reception section 812 receives different types of electronic receipt information depending on a format in which an electronic receipt is displayed.

The display control section 813, which is a display control section, converts the electronic receipt information including merchandise sales data, which is received by the reception section 812, into a format of an electronic receipt and displays the information on the display unit 87. In more detail, the display control section 813 converts the electronic receipt information to a format which is set through the input control section 811 and displays the electronic receipt in the converted format. Thereby, the display control section 813 may display an electronic receipt in which the display order of purchased merchandise is modified and/or additional information, such as calories (nutrition values) of food product, is added thereto. Further, the display control section 813 may display an electronic receipt without a store name logotype, which is set through the customized format setting.

The transmission section 814, which is a transmission section, transmits a transmission request signal for the electronic receipt information to be received by the reception section 812. At this time, the transmission section 814 transmits a transmission request signal for the electronic receipt information according to the setting of a format which is input by the input control section 811. For example, the transmission section 814 transmits a transmission request signal for the electronic receipt information having information regarding calories of merchandise when a format includes calories of merchandise (food products) in the electronic receipt to be displayed.

In addition, the transmission section 814 transmits a transmission request signal for the electronic receipt information having merchandise sales data for a predetermined period of time, when merchandise in an electronic receipt is rearranged in the order according to the frequency of purchase. The reception section 812 receives merchandise sales data for the predetermined period of time, which are returned in response to the transmission request signal. The display control section 813 calculates the frequency of merchandise purchase from the merchandise sales data for the predetermined period of time, and rearranges the display order of the purchased merchandise in a recent purchase transaction for which the electronic receipt is displayed. Here, the order in which the merchandise is displayed may be an ascending order or a descending order.

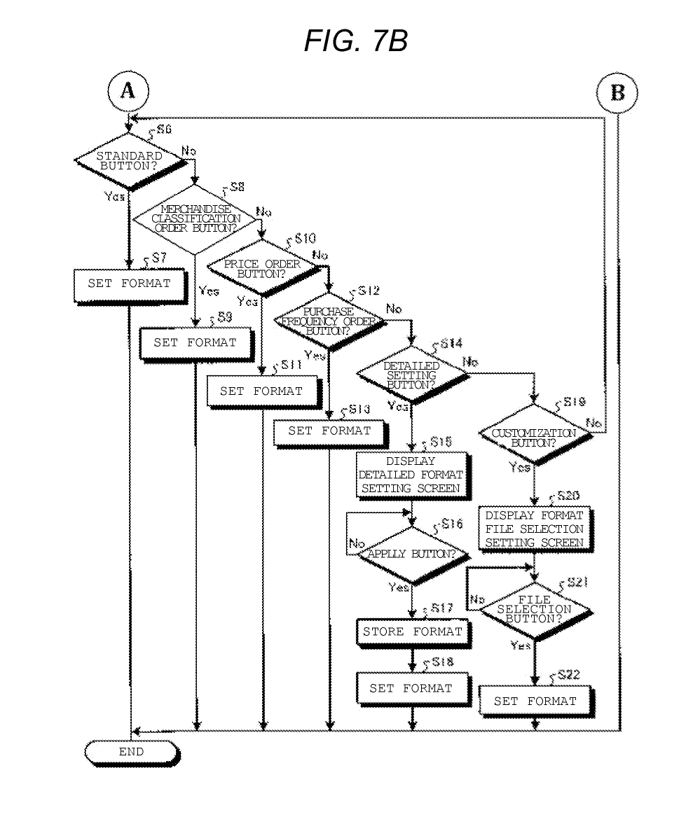

Next, a format setting process which is performed by the CPU 81 of the portable terminal 8 according to the present embodiment in accordance with a control program will be described. FIGS. 7A and 7B are flow charts illustrating a flow of a format setting process which is performed by the CPU 81 of the portable terminal 8 according to the embodiment in accordance with a control program.

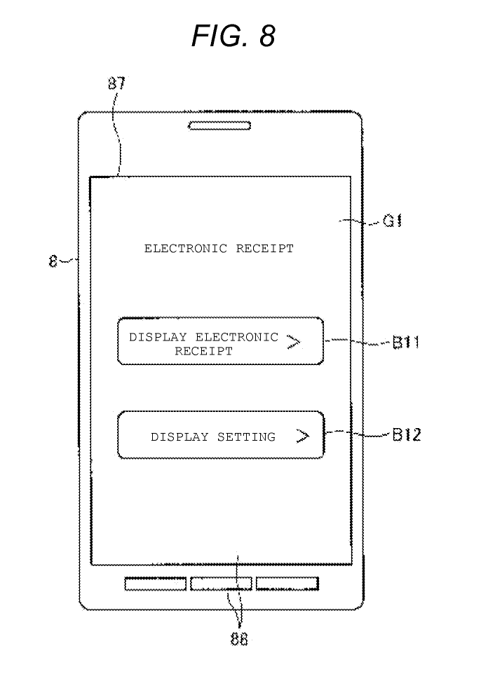

The CPU 81 of the portable terminal 8 starts the electronic receipt displaying program P82 and displays an initial screen (step S1). Here, FIG. 8 illustrates an example of an initial screen G1. The initial screen G1 includes an electronic receipt display button B11 and a display setting button B12. The electronic receipt display button B11 is a button to be selected to display an electronic receipt. The display setting button B12 is a button to be selected to perform setting of a format which is a form of an electronic receipt.

Subsequently, the CPU 81 of the portable terminal 8 determines whether or not the display setting button B12 is selected (step S2). When the display setting button B12 is not selected (step S2; No), the CPU 81 of the portable terminal 8 determines whether or not the electronic receipt display button B11 is selected (step S3). When the electronic receipt display button B11 is not selected (step S3; No), the CPU 81 of the portable terminal 8 returns to step S2.

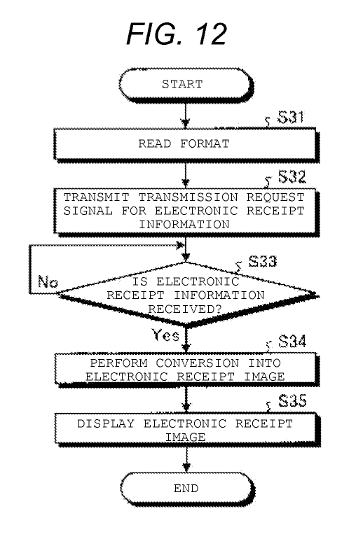

On the other hand, when the electronic receipt display button B11 is selected (step S3; Yes), the CPU 81 of the portable terminal 8 performs a process of displaying an electronic receipt (step S4) and terminates the process. The process of displaying an electronic receipt will be described using a flow chart of FIG. 12 in detail.

On the other hand, when the display setting button B12 is selected (step S2; Yes), the CPU 81 of the portable terminal 8 displays a format setting screen (step S5).

Here, FIG. 9 illustrates an example of a format setting screen G2. The format setting screen G2 is a screen for performing the simple format setting. In more detail, the format setting screen G2 includes a plurality of buttons for setting a format which is a form of an electronic receipt. The format setting screen G2 displays a message “simple format change” to indicate to a user that a format may be simply changed. In addition, the format setting screen G2 includes a merchandise classification order button B21, a price order button B22, a purchase frequency order button B23, a detailed setting button B24, a customization button B25, and a standard button B26.

The merchandise classification order button B21 is a button for setting a format in which merchandise displayed on an electronic receipt is sorted based on merchandise classification. The merchandise classification may be rough classification such as, for example, foods, clothes, and commodities. Alternatively, the merchandise classification may be detailed classification such as box lunches, meat, vegetables, and frozen foods. The price order button B22 is a button for setting a format in which merchandise displayed on an electronic receipt is sorted in the order of merchandise price. The purchase frequency order button B23 is a button for setting a format in which merchandise displayed on an electronic receipt is sorted in descending order of past purchase frequency. A user may perform the simple format setting by selecting one of the buttons B21-B23. The detailed setting button B24 is a button to be selected when the order of merchandise displayed on an electronic receipt is set through a detailed format setting screen G3 (see FIG. 10). The customization button B25 is a button to be selected to import a format file in which the format of an electronic receipt is set. The standard button B26 is a button to be selected to set a standard electronic receipt (default format).

The CPU 81 of the portable terminal 8 determines whether or not the standard button B26 is selected (step S6). When the standard button B26 is selected (step S6; Yes), the CPU 81 of the portable terminal 8 sets the format of an electronic receipt to a standard format stored in the format management region 83a of the storage unit 83 (step S7).

When the standard button B26 is not selected (step S6; No), the CPU 81 of the portable terminal 8 determines whether or not the merchandise classification order button B21 is selected (step S8). When the merchandise classification order button B21 is selected (step S8; Yes), the CPU 81 of the portable terminal 8 sets the format of an electronic receipt to a format in which merchandise is sorted based on merchandise classification and which is stored in the format management region 83a of the storage unit 83 (step S9).

When the merchandise classification order button B21 is not selected (step S8; No), the CPU 81 of the portable terminal 8 determines whether or not the price order button B22 is selected (step S10). When the price order button B22 is selected (step S10; Yes), the CPU 81 of the portable terminal 8 sets the format of an electronic receipt to a format in which merchandise is sorted in the order of merchandise price, and which is stored in the format management region 83a of the storage unit 83 (step S11).

When the price order button B22 is not selected (step S10; No), the CPU 81 of the portable terminal 8 determines whether or not the purchase frequency order button B23 is selected (step S12). When the purchase frequency order button B23 is selected (step S12; Yes), the CPU 81 of the portable terminal 8 sets the format of an electronic receipt to a format in which merchandise is sorted in descending order of past purchase frequency, and which is stored in the format management region 83a of the storage unit 83 (step S13).

When the purchase frequency order button B23 is not selected (step S12; No), the CPU 81 of the portable terminal 8 determines whether or not the detailed setting button B24 is selected (step S14). When the detailed setting button B24 is selected (step S14; Yes), the CPU 81 of the portable terminal 8 displays a detailed format setting screen (step S15).

Here, FIG. 10 illustrates an example of a detailed format setting screen G3. The detailed format setting screen G3 is a screen capable of setting a plurality of items related to the format of an electronic receipt. The detailed format setting screen G3 displays a message “format detailed setting” to indicate to a user that detailed format setting may be performed. The detailed format setting screen G3 includes a list display method setting region G31, a display contents setting region G32, a display order setting region G33, and an establishment button B31.

The list display method setting region G31 is a region for setting a method of displaying a list of merchandise on an electronic receipt. The list display method setting region G31 includes a no-classification radio button and a merchandise classification radio button. In the list display method setting region G31, it is possible to select either one of the no-classification radio button and the merchandise classification radio button. The no-classification radio button is to be selected to display purchased merchandise without being sorted based on merchandise classification. The merchandise classification radio button is to be selected to sort the purchased merchandise based on merchandise classification. The list display method setting region G31 illustrated in FIG. 10 shows a state where the no-classification radio button is selected.

The display contents setting region G32 is a region for setting display contents of each merchandise displayed on an electronic receipt. The display contents setting region G32 include a price (tax included) check box, a price (tax excluded) check box, a calorie check box, and a discount amount check box. The price (tax included) check box is checked when a tax included price of merchandise is displayed. The price (tax excluded) check box is checked when a tax excluded price of merchandise is displayed. The calorie check box is checked when calories are displayed in a case where the calories are associated with the target merchandise. The discount amount check box is checked when a discount amount is displayed in a case where the target merchandise is discounted. Multiple check boxes can be checked at the same time. The display contents setting region G32 illustrated in FIG. 10 shows a state where the price (tax included) check box is selected.

The display order setting region G33 is a region for setting the order in which merchandise displayed on an electronic receipt is sorted. The display order setting region G33 includes a scanning order radio button, a price order radio button, and a purchase frequency order radio button. The scanning order radio button is selected when merchandise displayed on an electronic receipt is sorted in the order in which the merchandise is scanned (registered). The price order radio button is selected when merchandise displayed on an electronic receipt is sorted in the order of merchandise price. The purchase frequency order radio button is selected when merchandise displayed on an electronic receipt is sorted in the order of the frequency of merchandise purchase. The display order setting region G33 illustrated in FIG. 10 shows a state where the scanning order radio button is selected. The apply button B31 is a button to be selected to apply contents input in the detailed format setting screen G3.

The CPU 81 of the portable terminal 8 determines whether or not the apply button B31 of the detailed format setting screen G3 is selected (step S16). When the apply button B31 is not selected (step S16; No), the CPU 81 of the portable terminal 8 goes in a standby state.

On the other hand, when the apply button B31 is selected (step S16; Yes), the CPU 81 of the portable terminal 8 stores a format, which is input in the detailed format setting screen G3, in the format management region 83a of the storage unit (step S17). Subsequently, the CPU 81 of the portable terminal 8 sets the format of an electronic receipt to the format applied through the detailed format setting screen G3 (step S18).

When the detailed setting button B24 is not selected (step S14; No), the CPU 81 of the portable terminal 8 determines whether or not the customization button B25 is selected (step S19). When the customization button B25 is not selected (step S19; No), the CPU 81 of the portable terminal 8 returns to step S6.

When the customization button B25 is selected (step S19; Yes), the CPU 81 of the portable terminal 8 displays a format file selection setting screen (step S20).

FIG. 11 illustrates an example of a format file selection screen G4. The format file selection screen G4 is a screen in which a desired format file is selected from format files of an electronic receipt which are stored in the unique format management region 83b of the storage unit 83. The format file selection screen G4 includes one or more file selection buttons B41. Each of the file selection buttons B41 is a button for setting a format file displayed to the format of an electronic receipt.

The CPU 81 of the portable terminal 8 determines whether or not one of the file selection buttons B41 of the format file selection screen G4 is selected (step S21). When one of the file selection buttons B41 is not selected (step S21; No), the CPU 81 of the portable terminal 8 goes into a standby state. On the other hand, when one of the file selection buttons B41 is selected (step S21; Yes), the CPU 81 of the portable terminal 8 sets the format of an electronic receipt to the format corresponding to the selected file selection button B41 (step S22).

As described above, the CPU 81 of the portable terminal 8 sets the format of an electronic receipt to be displayed on the display unit 87 of the portable terminal 8.

Next, a process of displaying an electronic receipt which is performed by the CPU 81 of the portable terminal 8 according to the present embodiment in accordance with a control program will be described. The process of displaying an electronic receipt is a process of displaying an electronic receipt which is shown in step S4 of the flow chart illustrated in FIG. 7A. FIG. 12 is a flow chart illustrating a flow of a process of displaying an electronic receipt which is performed by the CPU 81 of the portable terminal 8 according to the embodiment in accordance with a control program.

The flow chart illustrated in FIG. 12 is started when the electronic receipt display button B11 of the initial screen G1 illustrated in FIG. 8 is selected.

The CPU 81 of the portable terminal 8 reads a format which is stored in the format management region 83a or the unique format management region 83b of the storage unit 83 in accordance with a format set in the format setting process (step S31). Subsequently, the CPU 81 of the portable terminal 8 transmits a transmission request signal for the electronic receipt information according to the read format to the electronic receipt server 6 (step S32).

For example, when merchandise on an electronic receipt is sorted in the order of purchase frequency, the CPU 81 of the portable terminal 8 transmits a transmission request signal for obtaining merchandise sales data for a predetermined period of time, to the electronic receipt server 6. Thereby, the CPU 81 of the portable terminal 8 calculates the purchase frequency of merchandise purchased for the predetermined period of time and rearranges the display order the merchandise purchased in association with the recent purchase transaction for which the electronic receipt is generated.

Alternatively, for example, when calories of merchandise are displayed on an electronic receipt, the CPU 81 of the portable terminal 8 transmits a transmission request signal for the electronic receipt information including the calories of merchandise, to the electronic receipt server 6. As a result, the CPU 81 of the portable terminal 8 may include the calories of merchandise on the electronic receipt.

Subsequently, the CPU 81 of the portable terminal 8 determines whether or not electronic receipt information is received from the electronic receipt server 6 (step S33). When the electronic receipt information is not received (step S33; No), the CPU 81 of the portable terminal 8 goes into a standby state.

On the other hand, when the electronic receipt information is received (step S33; Yes), the CPU 81 of the portable terminal 8 converts the received electronic receipt information into an electronic receipt image according to the set format (step S34). Subsequently, the CPU 81 of the portable terminal 8 displays the generated electronic receipt image on the display unit 87 (step S35).

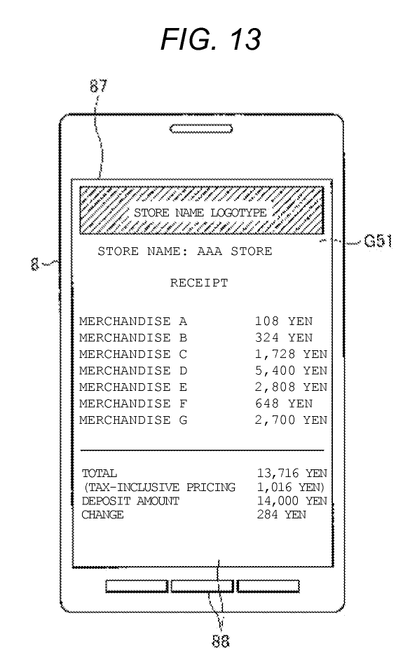

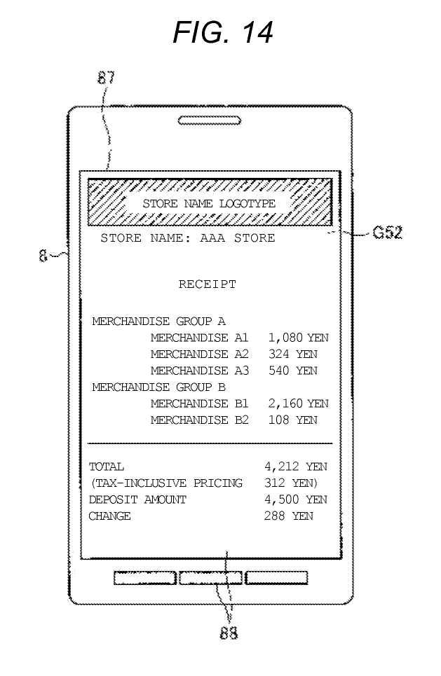

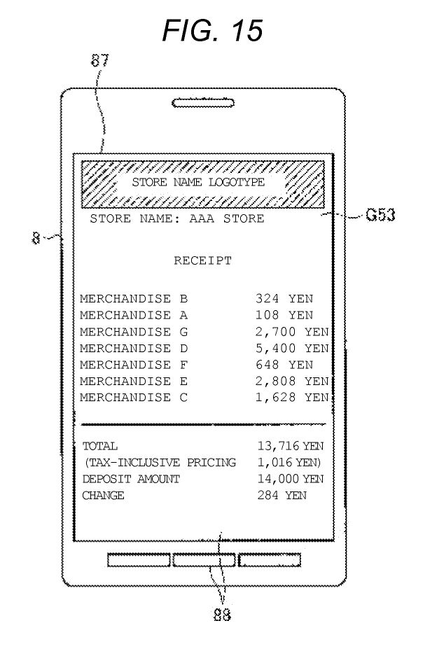

Here, FIG. 13 illustrates an example of an electronic receipt image G51 according to a standard format. FIG. 14 illustrates an example of an electronic receipt image G52 according to a format in which merchandise is sorted based on merchandise classification. FIG. 15 illustrates an example of an electronic receipt image G53 according to a format in which merchandise is sorted in the order of purchase frequency.

The electronic receipt image G51 according to the standard format which is illustrated in FIG. 13 is an image of an electronic receipt displayed in the same format as a paper receipt.

In the electronic receipt image G52 illustrated in FIG. 14, merchandise is categorized into one of multiple groups that are based on merchandise classification. Specifically, the electronic receipt image G52 shows a state where merchandise is classified into one of a merchandise group A and a merchandise group B. By using this format, a user may easily recognize the amount of merchandise purchased for each group. For example, when the merchandise group A is meat and the merchandise group B is vegetables, it is possible to recognize that the vegetables are less purchased than the meat or the like.

The electronic receipt image G53 illustrated in FIG. 15 is different from the electronic receipt image G51 illustrated in FIG. 13 in terms of the order in which the merchandise is displayed. By using this format, a user may recognize merchandise purchased (consumed) in relatively great quantities. Accordingly, the user may use the electronic receipt image G53 as information for determining whether or not to perform bulk purchase in the future shopping.

As described above, the CPU 81 of the portable terminal 8 displays an electronic receipt on the display unit 87 of the portable terminal 8.

As described above, according to the portable terminal 8 of the present embodiment, the reception section 812 receives electronic receipt information including merchandise sales data of purchased merchandise. The display control section 813 displays the electronic receipt information received by the reception section 812 on the display unit 87. In addition, the portable terminal 8 includes the input control section 811 that receives an input of setting a format which is a form of an electronic receipt displayed on the display unit 87. The display control section 813 converts the electronic receipt information received by the reception section 812 into the format input by the input control section 811 and displays the information on the display unit 87. Accordingly, a user may review an electronic receipt in a format according to his or her preference.

In the above-described embodiment, the formats of electronic receipts are stored in the format management region 83a and the unique format management region 83b, which are included in the storage unit 83 of the portable terminal 8. However, the formats of electronic receipts may be stored in an apparatus other than the portable terminal 8. For example, the formats of electronic receipts may be stored in the electronic receipt server 6 or the electronic receipt management server 9.

In the above-described embodiment, the reception section 812 of the portable terminal 8 receives different electronic receipt information depending on a format of an electronic receipt. However, electronic receipt information corresponding to all formats may be received. In this case, electronic receipt information corresponding to all formats is received, and an unnecessary portion of the received electronic receipt information may be discarded.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing device comprising:
a communication unit configured to communicate wirelessly with a server that stores electronic receipt data;
a memory unit configured to temporarily store electronic receipt data received from the server through the communication unit;
a display unit configured to display an user interface including a plurality of user selectable elements, each corresponding to a display format of a group of electronic receipts; and
a control unit configured to control the display unit to display the electronic receipts corresponding to the electronic receipt data stored in the memory unit, in one of the display formats selected through the user interface.

2. The computing device according to claim 1, wherein
each of the display formats corresponds to a unique display order of the purchased items that is in accordance with attribute information of the purchased items.

3. The computing device according to claim 2, wherein
the attribute information includes at least one of price, purchase frequency, and a nutrition value.

4. The computing device according to claim 1, wherein
the control unit is further configured to control the communication unit to transmit to the server a request designating the selected display format, and
the electronic receipt data received in response to the request from the server includes attribute information of the purchased items corresponding to the selected display format.

5. The computing device according to claim 1, wherein
the display formats include a preset format and a user defined format.

6. A method for displaying information of purchased items on a display unit of a computing device, comprising:
receiving electronic receipt data from a server that stores electronic receipt data, using a wireless communication;
temporarily storing electronic receipt data received from the server;
displaying a user interface including a plurality of user selectable elements, each corresponding to a display format of a group of electronic receipts;
receiving selection of one of the display formats through the user interface; and
displaying the electronic receipts corresponding to the stored electronic receipt data, in one of the display formats selected through the user interface.

7. The method according to claim 6, wherein
each of the display formats corresponds to a unique display order of the purchased items that is in accordance with attribute information of the purchased items.

8. The method according to claim 7, wherein
the attribute information includes at least one of price, purchase frequency, and a nutrition value.

9. The method according to claim 6, further comprising:
transmitting, from the computing device to the server, a request designating the selected display format, wherein
the electronic receipt data received from the server in response to the request includes attribute information of the purchased items corresponding to the selected display format.

10. The method according to claim 6, wherein
the display formats include a preset format and a user defined format.

11. A non-transitory computer readable medium comprising a program that is executable in a computing device to cause the computing device to perform a method for displaying information of purchased items on a display unit of a computing device, the method comprising:
receiving electronic receipt data from a server that stores electronic receipt data, using a wireless communication;
temporarily storing electronic receipt data received from the server;
displaying a user interface including a plurality of user selectable elements, each corresponding to a display format of a group of electronic receipts;
receiving selection of one of the display formats through the user interface; and
displaying the electronic receipts corresponding to the stored electronic receipt data, in one of the display formats selected through the user interface.

12. The non-transitory computer readable medium according to claim 11, wherein
each of the display formats corresponds to a unique display order of the purchased items that is in accordance with attribute information of the purchased items.

13. The non-transitory computer readable medium according to claim 12, wherein
the attribute information includes at least one of price, purchase frequency, and a nutrition value.

14. The non-transitory computer readable medium according to claim 11, wherein the method further comprises:
transmitting, from the computing device to the server, a request designating the selected display format, and wherein
the electronic receipt data received from the server in response to the request includes attribute information of the purchased items corresponding to the selected display format, and
the electronic receipt is generated also based on the received attribute information.

15. The non-transitory computer readable medium according to claim 11, wherein
the display formats include a preset format and a user defined format.
